(19) United States
(12) Patent Application Publication
(10) Pub. No.: US 2019/0090423 A1
(43) Pub. Date: Mar. 28, 2019

(54) WORKING MACHINE

(71) Applicant: CLAAS Selbstfahrende Erntemaschinen GmbH, Harsewinkel (DE)

(72) Inventors: MATHIAS ESCHER, OSTERCAPPELN (DE); JOACHIM BAUMGARTEN, BEELEN (DE); SEBASTIAN NEU, BAD LAER (DE); ARTHUR BERGER, BISSENDORF (DE); SASCHA DIECKMEYER, MELLE (DE)

(73) Assignee: CLAAS Selbstfahrende Erntemaschinen GmbH, Harsewinkel (DE)

(21) Appl. No.: 16/141,057

(22) Filed: Sep. 25, 2018

(30) Foreign Application Priority Data
Sep. 26, 2017 (DE) 102017122300.2

(51) Int. Cl. A01D 41/127

(52) U.S. Cl. CPC A01D 41/1277

(57) ABSTRACT

A working machine, in particular a combine harvester, having multiple working elements for carrying out or assisting work, and a driver assistance system for controlling the working elements according to at least one processing strategy which can be specified by the operator and directed to the fulfillment of at least one quality criterion. The driver assistance system has a memory for storing data characterizing the processing strategy, a computing device for processing the data stored in the memory, and a graphical user interface. Competing quality criteria, weighted with respect to each other according to a weighting variable, are incorporated into the processing strategy. The weighting variable is visualized via a virtual control element of the graphical user interface and can be specified by the operator. The driver assistance system registers the strategy selection of the operator, predicts an optimization goal, and presents an optimization proposal for this predicted optimization goal.

### CROSS REFERENCE TO RELATED APPLICATIONS

This application claims priority under 35 USC 119 of German Application No. DE 102017122300.2, filed on Sep. 26, 2017, the disclosure of which is herein incorporated by reference.

### BACKGROUND OF THE INVENTION

The invention relates to a working machine, in particular an agricultural working machine, a forestry machine, or construction machine, and to a method for controlling a working machine, in particular an agricultural working machine, a forestry machine, or construction machine.

The working machine under discussion can be any type of working machine, in particular an agricultural working machine, a forestry machine, a construction machine, a mining machine, or the like, which is utilized for carrying out a work order, in particular an agricultural work order, a forestry work order, a construction work order, or a mining work order, and which is equipped with several working elements as well as a driver assistance system for controlling the working elements. These working elements include, for example, towing vehicles, in particular tractors, self-propelled harvesting machines, in particular combine harvesters or forage harvesters, or the like. The working machine designed as a combine harvester is the focus in the present case.

A working machine designed as a combine harvester is utilized for mowing and for threshing grain. The threshing is carried out by a threshing unit which obtains kernels from the crop picked up by the combine harvester with the aid of the header. After threshing, separation, and subsequent cleaning, the kernels are fed to a grain tank. The chaff and the straw, for example, as further components of the crop, are left over and can either be spread onto the field or—in the case of straw—can be laid down in a windrow, for example, to be picked up at a later time with the aid of a baler. In this case and in the following, the term “crop” is to be understood to mean the entire crop stream picked up by the threshing unit, i.e., including the grains which have not yet been obtained from the crop as kernels, and the grains which may remain in the crop stream as a loss and are laid down with the straw.

In the threshing unit, the grain is rubbed (threshed) out of the straw by way of a processing which is rolling, in principle, and the grain is separated from the rest of the crop stream so that it can be fed directly to the cleaning process. The remaining crop stream is then fed to the separating area, in which the remaining grain is separated from the crop stream with the aid of a straw walker arrangement, for example, and is subsequently also fed to the cleaning process.

There are many quality criteria on the basis of which the quality of the agricultural working process, specifically the harvesting process in this case, can be evaluated. On the one hand, preferably all grain is to be removed from the crop stream and fed to the grain tank, specifically with the fewest broken kernels (damaged grain) possible and a low portion of non-grain in the kernels. Moreover, if possible, the straw is also not to be damaged to such a great extent and, for example, cut into small pieces, so that the subsequent utilization is made difficult. Finally, the time required for working a field is also to be kept as short as possible and/or the fuel consumed in doing so is to be kept as low as possible. The aforementioned quality criteria are mentioned here merely by way of example. Further quality criteria are also conceivable.

In order for the aforementioned quality criteria to be met, the threshing unit and the other working elements of the combine harvester must be controlled in a certain way. The driver assistance system is provided for this purpose. The driver assistance system carries out the control of the working elements according to at least one processing strategy which can be specified by the operator and is directed toward fulfilling at least one quality criterion. The fundamental mode of operation of the driver assistance system is described in EP 2 322 029 B1. The driver assistance system comprises a graphical user interface, with the aid of which at least a portion of the processing strategy can be specified by the operator. If the operator specifies quality criteria which compete with each other and cannot be simultaneously met, the driver assistance system preferably responds with an appropriate warning.

The known working machine (EP 3 178 307 A1), on which the invention is based, shows a driver assistance system, in the case of which the weighting of competing quality criteria of a processing strategy, specifically a harvesting strategy in this case, can be changed with the aid of a virtual control element in the form of a virtual sliding actuator. In this case, the operator can move the sliding actuator back and forth between the competing quality criteria “minimization of the working process parameter ‘damaged grain portion’” and “maximization of the working process parameter ‘threshed portion’”, and so the change of a weighting variable visualized via the virtual control element is associated with an opposite change in the weighting of the competing quality criteria. If the sliding actuator is moved, for example, in the direction “minimization of the working process parameter ‘damaged grain portion’”, the quality criterion “maximization of the working process parameter ‘threshed portion’” is underweighted as a result. The graphical user interface visualizes, in this case, various control elements which can be specified by the operator and with the aid of which a particular weighting variable, which is assigned to a group of quality criteria which compete with each other, can be changed. It is disadvantageous that, depending on the particular agricultural work order, further optimizations are meaningful, under certain circumstances, which would also require changes to further weighting variables. In this case, the operator must recognize the meaningful further optimizations and then make a separate entry to change each weighting variable.

### SUMMARY OF THE INVENTION

It is therefore an object of the invention to design and refine the known working machine in such a way that further optimizations can take place in a particularly simple way after a specification of a processing strategy by the operator.

The aforementioned problem is solved by a working machine according to the invention, in particular an agricultural working machine, a forestry machine, or a construction machine, comprising multiple working elements for carrying out or assisting work, and comprising a driver assistance system for controlling the working elements according to at least one processing strategy which can be specified by the operator and is directed to the fulfillment of at least one quality criterion. The driver assistance system comprises a memory for storing data using the at least one processing strategy, a computing device for processing the data stored in the memory, and a graphical user interface, wherein competing quality criteria, which have been weighted with respect to each other according to a weighting variable, are incorporated into the processing strategy, which weighting variable is visualized via a virtual control element of the graphical user interface and can be specified by the operator.

Of essential importance is the principle consideration that the driver assistance system, after having detected a change to a weighting variable carried out by the operator, makes an assumption as to which goal the operator would like to pursue with this change and subsequently proposes to the operator a change to at least one further weighting variable, which supports the attainment of the assumed goal of the operator. Preferably, the operator needs to change only one weighting variable, which is assigned to certain competing quality criteria, with the aid of the virtual control element and, subsequently, the driver assistance system automatically changes the weighting variables of other competing quality criteria, particularly preferably several or even all remaining weighting variables of competing quality criteria which are visualized via the graphical user interface.

Specifically, it is provided that the driver assistance system of the agricultural working machine according to the invention registers the strategy selection behavior of the operator, predicts an optimization goal on the basis of the registered strategy selection behavior, and presents a proposal for this predicted optimization goal. The essential advantage is that further optimizations can take place in a particularly easy way after a specification of a processing strategy is made by the operator, by way of the driver assistance system proposing, to the operator, meaningful further changes which the operator then merely needs to accept, for example.

According to one embodiment, the strategy selection behavior of the operator is registered on the basis of a change in the weighting variable which the operator has made. Therefore, if the operator displaces a virtual control element, for example, in particular with the aid of a drag-and-drop operation, in the direction of one of the competing quality criteria, the driver assistance system detects this change and subsequently predicts an optimization goal, on the basis of which an optimization is proposed.

According to another embodiment, the optimization proposal generated by the system is graphically displayed to the operator. Preferably, the operator has the option of accepting, i.e., confirming, and/or rejecting and/or adapting the optimization proposal. The operator can make corresponding entries on the graphical user interface and/or via the virtual control element.

According to a preferred embodiment, after the optimization proposal has been accepted and/or adapted, the driver assistance system makes a change to the weighting of the competing quality criteria, which corresponds to the optimization proposal. The change to the weighting is then incorporated into the processing strategy.

According to another embodiment, the driver assistance system implements particular assigned control measures in order to meet the quality criteria. In the case of quality criteria which compete with each other, the control measures are implemented so as to be weighted with respect to each other according to the weighting variable.

In principle, several weighting variables can be provided, to each of which competing quality criteria are assigned. In one embodiment, the competing quality criteria are assigned in pairs to one weighting variable in each case. In principle, it is also conceivable, however, that assigned to one weighting variable are several quality criteria, in particular three quality criteria, which partially compete with each other.

In another embodiment, the virtual control element has a central position which corresponds to a balance of the competing quality criteria with respect to each other. A displacement out of the central position then effectuates a corresponding change in the weighting variable depending on the displacement direction. The change in the weighting variable is associated with a mutually opposite change in the weighing of the competing quality criteria.

Other embodiments relate to the application of the teaching according to the invention to a working machine designed as a combine harvester. In the case of a combine harvester, there is a plurality of quality criteria which compete with each other. One example thereof is the quality criterion of the maximization of the threshed portion, which is simultaneously associated with a reduction in the throughput, however, which, in turn, results in a greater amount of time being required and a higher fuel consumption during the implementation of the agricultural work order. Therefore, the quality criteria “maximization of the threshed portion” and the “maximization of the throughput” are two competing quality criteria in the above-described sense.

According to yet another teaching, a method for the control of the agricultural working machine according to the invention is claimed as such.

According to the method according to the invention, it is essential that the driver assistance system registers the strategy selection behavior of the operator, predicts an optimization goal on the basis of the registered strategy selection behavior, and presents a proposal for this predicted optimization goal. The optimization proposal can then be accepted, changed, or rejected by the operator. It is also conceivable, however, that the optimization proposal is automatically accepted or set by the system. Reference is made to all comments made with respect to the agricultural working machine according to the invention explaining the method according to the invention.

### BRIEF DESCRIPTION OF THE DRAWINGS

The invention is explained in the following in greater detail with reference to a drawing representing only one exemplary embodiment. In the drawing:

FIG. 1 shows a highly schematic representation of a working machine according to the invention, and

FIG. 2 shows a graphical user interface of the driver assistance system of the working machine according to FIG. 1, specifically in a) before a specification of a processing strategy by the operator and in b) after a specification of a processing strategy by the operator.

### DETAILED DESCRIPTION OF THE EMBODIMENTS

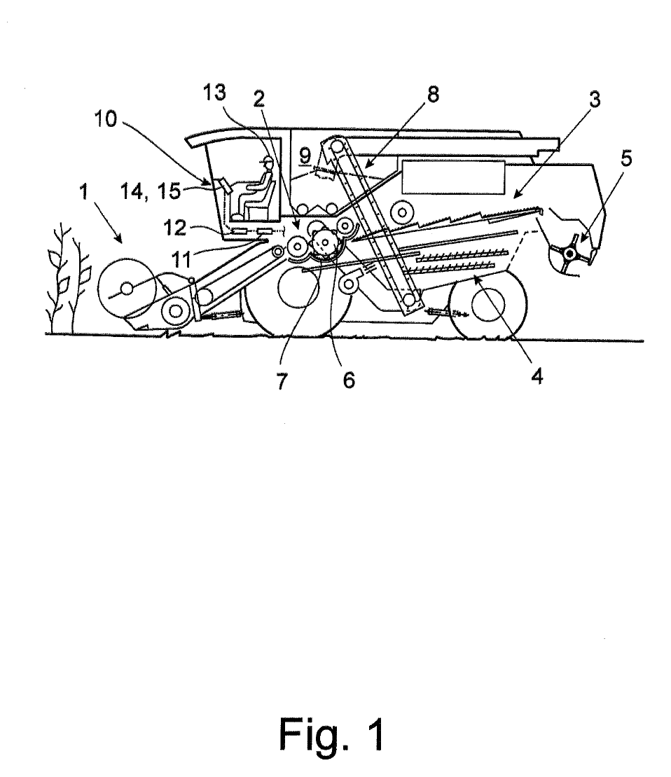

The working machine represented in FIG. 1 is designed as an agricultural working machine in this case, merely by way of example, and is utilized for carrying out a working process, specifically an agricultural working process in this case. In this case and preferably, the working machine is a combine harvester which is utilized for carrying out a harvesting process. The solution according to the invention can also be utilized on all other agricultural working machines mentioned in the introductory part. Although all the following comments consistently relate to a combine harvester, they also apply for all other types of agricultural working machines.

The represented agricultural working machine comprises the working elements including a header 1, threshing unit 2, separating system 3, cleaning system 4, and spreading system 5.

While the header 1 is utilized for cutting and picking up the crop, the threshing unit 2 has the task of threshing the picked-up crop to obtain grain. Crop is intended to mean the entirety of material that is picked up from the field crop and fed to the threshing unit 2, wherein grain refers to the kernels to be obtained from the crop by the combine harvester.

The threshing unit 2 is equipped with a threshing cylinder 6 which interacts with a threshing concave 7. The crop stream fed to the threshing unit 2 is therefore subsequently fed—without the grain which has already been obtained here—to the separating system 3. In principle, the threshing unit 2 is utilized for rubbing the predominant portion of the grain out of the crop by means of the threshing process. In the separating system 3, the crop is then moved, for example, shaken, along with the grain portion remaining therein, in such a way that the remaining grain is also preferably separated from the straw and the rest of the crop. The grain obtained in the threshing unit 2 and in the separating system 3 is then fed to a cleaning system 4. In the cleaning system 4, which usually has multiple stages, material other than grain, for example, chaff and straw parts, which has been carried along in the grain up to this point, as well as non-threshed material, such as, for example, ear tips or awns, are separated from the grain. The cleaned grain then passes via a transport system 8, for example, a grain elevator, into a grain tank 9. The threshed straw, i.e., the crop remaining in the separating system 3, is deposited by the combine harvester, for example, as swath, along the wheel track via the spreading system 5.

An upper threshing unit 2 can be controlled by way of the specification of various machine parameters which include, depending on the design of the threshing unit 2, drive parameters such as a cylinder speed or any other motion characteristic values of the threshing cylinder 6, as well as a concave width, i.e., the distance between the threshing cylinder 6 and the threshing concave 7. Provided the threshing unit 2 comprises filler plates, the filler plates can also be adjusted within the scope of the control of the threshing unit 2.

The working machine according to the invention further comprises a driver assistance system 10 for controlling the working elements 1 to 5. The driver assistance system 10 comprises a memory 11 for the storage of data which characterize at least one processing strategy, i.e., a memory 11 within the scope of information technology, as well as a processing device 12 for processing the data stored in the memory 11. In principle, the driver assistance system 10 is configured for assisting the operator 13 of the agricultural working machine in the operation of the agricultural working machine.

The driver assistance system 10 controls the working elements 1 to 5, which are mentioned here merely by way of example, according to at least one processing strategy which can be specified by the operator. The processing strategy is directed toward the fulfillment of at least one quality criterion. Taking the combine harvester as an example, the quality criteria are preferably the target of the setting or of the optimization of at least one harvesting process parameter such as “damaged grain portion”, “threshed portion”, “cleanliness”, “straw quality”, and “throughput”. The harvesting process parameter “throughput” is combined with the harvesting process parameter “fuel consumption” in this case, since an increase in the throughput results in an increase in the absolute fuel consumption, and vice versa. In principle, even further working process parameters or harvesting process parameters can also be provided, for example, “losses due to separation”, “slip”, “threshing unit drive”, etc., to name only a few further examples.

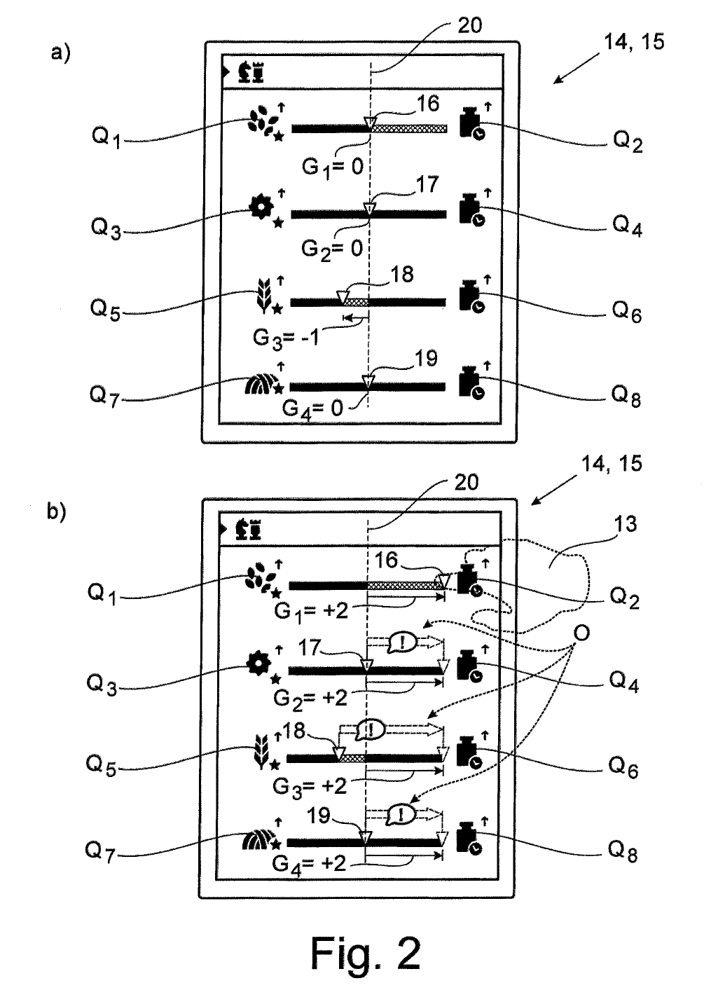

According to the invention, the driver assistance system 10 is equipped with a graphical user interface 14 comprising a display 15, via which the at least one portion of the processing strategy can be specified by the operator. In one particularly preferred embodiment, the graphical user interface 14 is a touchscreen monitor. Such a touchscreen monitor is represented in FIGS. 2a and 2b by way of example.

Competing quality criteria Q₁, Q₂; Q₃, Q₄; Q₅, Q₆; Q₇, Q₈, which are a component of the processing strategy which can be specified by the operator, can be visualized on the graphical user interface. The term “competing” is to be understood, with respect to two quality criteria in each case, in such a way that the fulfillment of the one quality criterion Q₁, Q₃, Q₅, Q₇ thwarts the fulfillment of at least one other quality criterion Q₂, Q₄, Q₆, Q₈, respectively, and vice versa. A control of the working elements 1 to 5, which is directed to the fulfillment of both quality criteria Q₁, Q₂; Q₃, Q₄; Q₅, Q₆; Q₇, Q₈, cannot be implemented in the case of quality criteria which are competing in such a way. A weighting variable G₁, G₂, G₃, G₄ is therefore assigned to competing quality criteria Q₁, Q₂; Q₃, Q₄; Q₅, Q₆; Q₇, Q₈, respectively, which represents a weighting of competing quality criteria Q₁, Q₂; Q₃, Q₄; Q₅, Q₆; Q₇, Q₈ with respect to each other. According to this weighting, i.e., according to this weighting variable G₁, G₂, G₃, G₄, the competing quality criteria Q₁, Q₂; Q₃, Q₄; Q₅, Q₆; Q₇, Q₈ are therefore incorporated into the processing strategy in such a way as to be weighted with respect to each other. The driver assistance system 10 assigns a higher priority to the quality criterion having the higher weighting in the control of the working elements 1 to 5 than to a quality criterion having a lower weighting.

The weighting variable G₁, G₂, G₃, G₄ assigned to the competing quality criteria Q₁, Q₂; Q₃, Q₄; Q₅, Q₆; Q₇, Q₈, respectively, is visualized via a virtual control element 16 to 19 of the graphical user interface 14 and its values can be specified by the operator. This is shown in the representation according to FIG. 2a. As is clear from FIG. 2a, the weighting variable G₁, G₂, G₃, G₄ can be visualized and adjusted with the aid of the control element 16 to 19 designed as a sliding actuator. In this case and preferably, assigned to the control elements 16 to 19 is a central position 20 which represents a balanced consideration of the quality criteria Q₁, Q₂; Q₃, Q₄; Q₅, Q₆; Q₇, Q₈ which are competing with each other. A deflection of the particular control element 16 to 19 out of the central position 20 corresponds to a corresponding change in the weighting variable G₁, G₂, G₃, G₄. In this case and preferably, a weighting variable G₁, G₂, G₃, G₄ is assigned to pairs of quality criteria Q₁, Q₂; Q₃, Q₄; Q₅, Q₆; Q₇, Q₈, respectively, which are competing in pairs. In principle, it can also be provided, however, that one common weighting variable which can be visualized and specified in the described way is assigned to an arbitrary group of competing quality criteria, for example, to a group of three quality criteria in each case.

With respect to the approach according to the invention, it is now essential that the driver assistance system 10 registers the strategy selection behavior of the operator 13 and predicts an optimization goal based on the registered strategy selection behavior. In other words, the driver assistance system 10 makes an assumption, based on one or multiple changes to weighting variables G₁, G₂, G₃, G₄ input by the operator, about the reason why the operator 13 could have implemented the particular change to the weighting variable or weighting variables G₁, G₂, G₃, G₄. This assumption or prediction made by the driver assistance system 10 is then utilized by the driver assistance system 10 as the basis for generating and proposing an optimization proposal O to the operator 13. The optimization proposal O is therefore based on the optimization goal assumed by the driver assistance system 10. Therefore, after the operator 13 has changed one or possibly several of the weighting variables G₁, G₂, G₃, G₄ him/herself, the driver assistance system 10 proposes, to the operator 13, additional changes to further of the weighting variables G₁, G₂, G₃, G₄, which are meaningful in this context.

In the exemplary embodiment represented in FIGS. 2a and 2b, four pairs of competing quality criteria Q₁, Q₂; Q₃, Q₄; Q₅, Q₆; Q₇, Q₈ and, correspondingly, weighting variables G₁, G₂, G₃, G₄ assigned to each pair are visualized on the graphical user interface 14 or the display 15, by way of example.

The competing quality criteria Q₁, Q₂ in this case are the minimization of the working process parameter “damaged grain portion” (left side) and the maximization of the working process parameter “throughput” (right side). The competing quality criteria Q₃, Q₄ in this case are the maximization of the working process parameter “threshed portion” (left side) and the maximization of the working process parameter “throughput” (right side). The competing quality criteria Q₅, Q₆ are the maximization of the working process parameter “cleanliness” (left side) and the maximization of the working process parameter “throughput” (right side). Finally, the competing quality criteria Q₇, Q₈ in this case are the maximization of the working process parameter “straw quality” (left side) and the maximization of the working process parameter “throughput” (right side).

Assigned to the pair of competing quality criteria Q₁, Q₂ in this case is the control element 16 which is situated in the central position 20 in FIG. 2a, and so the weighting variable G₁ is zero in this case. Therefore, there is a balance between the working process parameters “damaged grain portion” and “throughput” in this case. Assigned to the pair of competing quality criteria Q₃, Q₄ in this case is the control element 17 which is also situated in the central position 20 in FIG. 2a, and so the weighting variable G₂ is also zero. Therefore, there is a balance between the working process parameters “threshed portion” and “throughput” in this case. Assigned to the pair of competing quality criteria Q₅, Q₆ in this case is the control element 18 which has been displaced from the central position 20 toward the working process parameter “cleanliness” in FIG. 2a, and so the weighting variable G₃ has a value of −1, for example, in this case. This means, the working process parameter “cleanliness” is overweighted with respect to the working process parameter “throughput” in this case. In this case and preferably, the cleaning quality of the grain is therefore increased in the cleaning system 4, which is associated with a reduction in the throughput. Finally, assigned to the pair of competing quality criteria Q₇, Q₈ in this case is the control element 19 which is also situated in the central position 20 in FIG. 2a, and so the weighting variable G₄ is also zero in this case. The working process parameter “straw quality” is therefore also balanced with respect to the working process parameter “throughput”.

FIG. 2a shows a state before the operator 13 specifies a new processing strategy and, therefore, changes the previous processing strategy. The state after the operator 13, which is symbolized in this case by a dotted-line hand, has specified the new processing strategy is represented in FIG. 2b. In this case and preferably, the operator 13 has selected a processing strategy which is directed to a maximization of the throughput.

Specifically, the operator 13 has displaced the control element 16 out of the central position 20 toward the right, by the maximum amount, to the working process parameter “throughput” for this purpose. After the displacement, the corresponding weighting variable G₁ has a value, for example, of +2 which is a maximum value in this case. The working process parameter “throughput” is therefore overweighted with respect to the working process parameter “damaged grain portion” by the maximum possible amount. The driver assistance system 10 registers the strategy selection behavior of the operator 13 and, therefore, recognizes the selection of the new processing strategy, according to which the working process parameter “throughput” is to be weighted with respect to the working process parameter “damaged grain portion” by the maximum amount, and subsequently assumes that the operator 13 places value on a highest possible throughput during the execution of the agricultural work order. On the basis of the registered strategy selection behavior, the driver assistance system 10 therefore predicts the maximization of the working process parameter “throughput” as an optimization goal.

For this predicted optimization goal, the driver assistance system 10 then subsequently presents an optimization proposal O which, in this case and preferably, consists of also displacing the weighting variables G₂, G₃, G₄ of the remaining pairs of competing quality criteria Q₃, Q₄; Q₅, Q₆; Q₇, Q₈ toward the working process parameter “throughput” by the maximum amount. The driver assistance system 10 therefore proposes to overweight the working process parameter “throughput” also with respect to each of the other quality criteria Q₃, Q₅, Q₇ competing therewith.

In this case and preferably, the optimization proposal O presented by the system is visualized on the graphical user interface 14. The visualization takes place in this case via the particular virtual control element 17 to 19, namely by symbolizing a displacement of the particular virtual control element 17 to 19 from its starting position into a position proposed by the system, which, for example, is the position representing the maximum throughput in this case. This is symbolized, for example, by way of the particular virtual control element 17 to 19, which is still situated in the starting position, additionally being represented once more in the position proposed by the system. The representation in the position proposed by the system can deviate from the representation in the actual starting position in this case, for example, by way of the particular control element 17 to 19 having a different color and/or a different contrast and/or a different contour, for example a dashed-line contour in this case, in the position proposed by the system.

The operator 13 can now partially or completely accept the optimization proposal O, which is visualized by the system on the graphical user interface 14, by way of an operator input in this case and preferably. An operator input is, in particular, an input on the graphical user interface 14, for example, by tapping on the virtual control element 17 to 19 represented in the position proposed by the system. It is also conceivable to provide an operator input via the particular virtual control element 17 to 19 in such a way that the operator 13 displaces the particular virtual control element 17 to 19 from the starting position into the proposed position. An appropriate input is then an acceptance or confirmation of the optimization proposal O submitted by the system. It is also conceivable that the operator 13 can reject the optimization proposal O, which could also take place by way of an operator input. In principle, it could also be provided that the optimization proposal O is displayed only for a certain period and is automatically removed after a corresponding length of time has passed, and so the operator, instead of actively rejecting an optimization proposal O, additionally or alternatively has the option of waiting for the predefined length of time to pass until the optimization proposal O is removed.

It is also conceivable that the optimization proposal O can be adapted by the operator, which can also take place via an operator input on the graphical user interface 14 and/or via the particular virtual control element 17 to 19, for example, by displacing the particular virtual control element 17 to 19 into a position other than that proposed by the driver assistance system 10.

With respect to the exemplary embodiment represented in FIG. 2b, it is provided, in summary, that two competing quality criteria Q₁, Q₂ are the minimization of the working process parameter “damaged grain portion” and the maximization of the working process parameter “throughput”, wherein, based on a change, made the operator, to the weighting variable G₁ which is assigned to these competing quality criteria Q₁, Q₂, the optimization proposal O which is proposed and visualized is a change to the weighting of the competing quality criteria Q₃, Q₄ “maximization of the working process parameter ‘threshed portion’” and “maximization of the working process parameter ‘throughput’” and/or the weighting of the competing quality criteria Q₅, Q₆ “maximization of the working process parameter ‘cleanliness’” and “maximization of the working process parameter ‘throughput’” and/or the weighting of the competing quality criteria Q₇, Q₈ “maximization of the working process parameter ‘straw quality’” and “maximization of the working process parameter ‘throughput’”.

The driver assistance system 10 also permits, in this case and preferably, the prediction of an optimization goal and the presentation of a corresponding optimization proposal O when the operator 13 makes a change to or a selection of a processing strategy which differs from that described above by way of example, for example when the operator 13 changes the weighting variable G₂ and/or the weighting variable G₃ and/or the weighting variable G₄.

Therefore, for example, the case is also conceivable that two competing quality criteria Q₃, Q₄ are the maximization of the working process parameter “threshed portion” and the maximization of the working process parameter “throughput”, wherein, based on a change, made by the operator, to the weighting variable G₂ which is assigned to these competing quality criteria Q₃, Q₄, the optimization proposal O which is proposed and visualized is a change to the weighting of the competing quality criteria Q₂, Q₂ “minimization of the working process parameter ‘damaged grain portion’” and “maximization of the working process parameter ‘throughput’” and/or the weighting of the competing quality criteria Q₅, Q₆ “maximization of the working process parameter ‘cleanliness’” and “maximization of the working process parameter ‘throughput’” and/or the weighting of the competing quality criteria Q₇, Q₈ “maximization of the working process parameter ‘straw quality’” and “maximization of the working process parameter ‘throughput’”.

Alternatively or additionally, the case is also conceivable that two competing quality criteria Q₅, Q₆ are the maximization of the working process parameter “cleanliness” and the maximization of the working process parameter “throughput”, wherein, based on a change, entered by the operator, to the weighting variable G₃ which is assigned to these competing quality criteria Q₅, Q₆, the optimization proposal O which is proposed and visualized is a change to the weighting of the competing quality criteria Q₁, Q₂ “minimization of the working process parameter ‘damaged grain portion’” and “maximization of the working process parameter ‘throughput’” and/or the weighting of the competing quality criteria Q₃, Q₄ “maximization of the working process parameter ‘threshed portion’” and “maximization of the working process parameter ‘throughput’” and/or the weighting of the competing quality criteria Q₇, Q₈ “maximization of the working process parameter ‘straw quality’” and “maximization of the working process parameter ‘throughput’”.

Moreover, the case is also conceivable that two competing quality criteria Q₇, Q₈ are the maximization of the working process parameter “straw quality” and the maximization of the working process parameter “throughput”, wherein, based on a change, entered by the operator, to the weighting variable G₄ which is assigned to these competing quality criteria Q₇, Q₈, the optimization proposal O which is proposed and visualized is a change to the weighting of the competing quality criteria Q₁, Q₂ “minimization of the working process parameter ‘damaged grain portion’” and “maximization of the working process parameter ‘throughput’” and/or the weighting of the competing quality criteria Q₃, Q₄ “maximization of the working process parameter ‘threshed portion’” and “maximization of the working process parameter ‘throughput’” and/or the weighting of the competing quality criteria Q₅, Q₆ “maximization of the working process parameter ‘cleanliness’” and “maximization of the working process parameter ‘throughput’”.

For the sake of completeness, it is pointed out that, in the exemplary embodiment described here, one of the two working process parameters in each pair of quality criteria Q₁, Q₂; Q₃, Q₄; Q₅, Q₆; Q₇, Q₈ is always “throughput”, by way of example. In principle, however, other quality criteria which compete with each other can also be provided, the particular weighting variable of which can be changed by the operator and/or the system, as described above. For example, the minimization of the working process parameter “damaged grain portion” and the maximization of the working process parameter “threshed portion” could also be compared in this case, as competing quality criteria.

Based on the optimization proposal O accepted and/or adapted by the operator, the driver assistance system 10 then implements a change in the weighting of the particular competing quality criteria Q₁, Q₂; Q₃, Q₄; Q₅, Q₆; Q₇, Q₈, which is then finally incorporated into the processing strategy.

According to yet another teaching, which has independent significance, a method for the control of the agricultural working machine according to the invention is claimed.

It is essential for the method according to the invention that the driver assistance system 10 registers the strategy selection behavior of the operator 13, predicts an optimization goal on the basis of the registered strategy selection behavior, and submits an optimization proposal O for this predicted optimization goal. Reference is made, in this regard, to all comments related to the mode of operation of the agricultural working machine according to the invention.

### LIST OF REFERENCE SIGNS

1 header

2 threshing unit

3 separating device

4 cleaning system

5 spreading system

6 threshing cylinder

7 threshing concave

8 transport system

9 grain tank

10 driver assistance system

11 memory

12 computing device

13 user

14 user interface

15 display

16-19 control elements

20 central position

Q₁-Q₈ quality criteria

G₁-G₄ weighting variables

What is claimed is:

1. A working machine, in particular an agricultural working machine, a forestry machine, or a construction machine, comprising:
multiple working elements for carrying out or assisting work; and
a driver assistance system configured for controlling the working elements according to at least one processing strategy which can be specified by the operator and is directed to fulfillment of at least one quality criterion, the driver assistance system comprising:
a memory configured for storing data characterizing the at least one processing strategy;
a computing device configured for processing the data stored in the memory; and
a graphical user interface;
wherein competing quality criteria, which have been weighted with respect to each other according to a weighting variable, are incorporated into the processing strategy, which weighting variable is visualized via a virtual control element of the graphical user interface and can be specified by the operator; and
wherein the driver assistance system is configured to register a strategy selection behavior of the operator, predict an optimization goal on the basis of the registered strategy selection behavior, and present an optimization proposal for this predicted optimization goal.

2. The working machine as claimed in claim 1, wherein the driver assistance system is configured for registering strategy selection behavior of the operator on the basis of a change to the weighting variable made by the operator.

3. The working machine as claimed in claim 1, wherein the virtual control element is configured for displacing the weighting variable with the aid of a drag-and-drop operation, and the change in the weighting variable is effectuated by way of a displacement of the virtual control element.

4. The working machine as claimed in claim 1, wherein the optimization proposal is visualized on the graphical user interface and/or via the virtual control element.

5. The working machine as claimed in claim 1, wherein the optimization proposal can be accepted and/or rejected and/or adapted by way of an operator input.

6. The working machine as claimed in claim 5, wherein the operator input is an input on the graphical user interface and/or via the virtual control element.

7. The working machine as claimed in claim 1, wherein the driver assistance system is configured to make a change, based on the accepted and/or adapted optimization proposal, to the weighting of the competing quality criteria, which is then incorporated into the processing strategy.

8. The working machine as claimed in claim 1, wherein the driver assistance system is configured to carry out respectively assigned control measures in order to fulfill the quality criteria and the driver assistance system carries out the assigned control measures, which have been weighted with respect to each other according to the weighting variable, in order to fulfill quality criteria which compete with each other.

9. The working machine as claimed in claim 1, wherein a weighting variable is assigned to competing pairs of quality criteria, and is visualized via a virtual control element of the graphical user interface and can be specified by the operator.

10. The working machine as claimed in claim 9, wherein the virtual control element has a central position which corresponds to a balance of the competing quality criteria, which are assigned to the control element, with respect to each other, and a displacement of the virtual control element from the central position effectuates a change in the weighting variable, depending on the displacement direction, and, therefore, a change to the weighting of the quality criteria with respect to each other.

11. The working machine as claimed in claim 9, wherein two competing quality criteria are the minimization of the working process parameter “damaged grain portion” and the maximization of the working process parameter “throughput”, wherein, based on a change, made by the operator, to the weighting variable which is assigned to these competing quality criteria, the optimization proposal which is proposed and visualized is a change to the weighting of the competing quality criteria “maximization of the working process parameter ‘threshed portion’” and “maximization of the working process parameter ‘throughput’” and/or the weighting of the competing quality criteria “maximization of the working process parameter ‘cleanliness’” and “maximization of the working process parameter ‘throughput’” and/or the weighting of the competing quality criteria “maximization of the working process parameter ‘straw quality’” and “maximization of the working process parameter ‘throughput’”.

12. The working machine as claimed in claim 11, wherein two competing quality criteria are the maximization of the working process parameter “threshed portion” and the maximization of the working process parameter “throughput”, wherein, based on a change, made by the operator, to the weighting variable which is assigned to these competing quality criteria, the optimization proposal which is proposed and visualized is a change to the weighting of the competing quality criteria “minimization of the working process parameter ‘damaged grain portion’” and “maximization of the working process parameter ‘throughput’” and/or the weighting of the competing quality criteria “maximization of the working process parameter ‘cleanliness’” and “maximization of the working process parameter ‘throughput’” and/or the weighting of the competing quality criteria “maximization of the working process parameter ‘straw quality’” and “maximization of the working process parameter ‘throughput’”.

13. The working machine as claimed in claim 11, wherein two competing quality criteria are the maximization of the working process parameter “cleanliness” and the maximization of the working process parameter “throughput”, wherein, based on a change, made by the operator, to the weighting variable which is assigned to these competing quality criteria, the optimization proposal which is proposed and visualized is a change to the weighting of the competing quality criteria “minimization of the working process parameter ‘damaged grain portion’” and “maximization of the working process parameter ‘throughput’” and/or the weighting of the competing quality criteria “maximization of the working process parameter ‘threshed portion’” and “maximization of the working process parameter ‘throughput’” and/or the weighting of the competing quality criteria “maximization of the working process parameter ‘straw quality’” and “maximization of the working process parameter ‘throughput’”.

14. The working machine as claimed in claim 11, wherein two competing quality criteria are the maximization of the working process parameter “straw quality” and the maximization of the working process parameter “throughput”, wherein, based on a change, made by the operator, to the weighting variable which is assigned to these competing quality criteria, the optimization proposal which is proposed and visualized is a change to the weighting of the competing quality criteria “minimization of the working process parameter ‘damaged grain portion’” and “maximization of the working process parameter ‘throughput’” and/or the weighting of the competing quality criteria “maximization of the working process parameter ‘threshed portion’” and “maximization of the working process parameter ‘throughput’” and/or the weighting of the competing quality criteria “maximization of the working process parameter ‘cleanliness’” and “maximization of the working process parameter ‘throughput’”.

15. A method for controlling a working machine, in particular an agricultural working machine, a forestry machine, or a construction machine, comprising multiple working elements for carrying out or assisting work, and comprising a driver assistance system for controlling the working elements according to at least one processing strategy which can be specified by the operator and is directed to the fulfillment of at least one quality criterion, wherein the driver assistance system comprises a memory for storing data characterizing the at least one processing strategy, a computing device for processing the data stored in the memory, and a graphical user interface, wherein competing quality criteria, which have been weighted with respect to each other according to a weighting variable, are incorporated into the processing strategy, which weighting variable is visualized via a virtual control element of the graphical user interface and can be specified by the operator, the method comprising the steps of:
registering with the driver assistance system the strategy selection behavior of the operator,
predicting with the driver assistance system an optimization goal on the basis of the registered strategy selection behavior, and
presenting an optimization proposal for the predicted optimization goal.
